(19) United States
(12) Patent Application Publication
(10) Pub. No.: US 2008/0059178 A1
(43) Pub. Date: Mar. 6, 2008

(54) Interface apparatus, interface processing method, and interface processing program

(75) Inventors: Daisuke Yamamoto, Kawasaki-Shi (JP); Miwako Doi, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/819,651

(22) Filed: Jun. 28, 2007

(30) Foreign Application Priority Data
Aug. 30, 2006 (JP) 2006-233468

(51) Int. Cl. G10L 15/04

(52) U.S. Cl. 704/251; 704/E15.005

(57) ABSTRACT

An interface apparatus of an embodiment of the present invention is configured to perform a device operation in response to a voice instruction from a user. The interface apparatus detects a state change or state continuation of a device or the vicinity of the device; queries a user by voice about the meaning of the detected state change or state continuation; has a speech recognition unit recognize a teaching speech uttered by the user in response to the query; associates a recognition result for the teaching speech with a detection result for the state change or state continuation, and accumulate a correspondence between the recognition result for the teaching speech and the detection result for the state change or state continuation; has a speech recognition unit recognize an instructing speech uttered by a user for a device operation; compares a recognition result for the instructing speech with accumulated correspondences between recognition results for teaching speeches and detection results for state changes or state continuations, and select a device operation specified by a detection result for a state change or state continuation that corresponds to the recognition result for the instructing speech; and performs the selected device operation.

### CROSS REFERENCE TO RELATED APPLICATIONS

This application is based upon and claims the benefit of priority from the prior Japanese Patent Application No. 2006-233468, filed on Aug. 30, 2006, the entire contents of which are incorporated herein by reference.

### BACKGROUND OF THE INVENTION

1. Field of the Invention

The present invention relates to an interface apparatus, an interface processing method, and an interface processing program.

2. Related Art

In recent years, due to the development of information technology, household appliances have come to be connected to networks. Furthermore, due to the spread of broadband, household appliances have come to be employed to construct home networks in households. Such household appliances are called information appliances. Information appliances are useful to users.

On the other hand, interfaces between information appliances and users are not always user-friendly. Information appliances have come to provide various useful functions and various usages, but due to such a wide choice of functions, users have come to be required to make many selections to use a function they want to use; this causes user-unfriendliness of the interfaces. Therefore, there is a need for a user-friendly interface that serves as an intermediary between an information appliance and a user and allows every user to operate a device (information appliance) and to understand device information easily.

One of known interfaces having such features is a speech interface, which performs a device operation in response to a voice instruction from a user. In such a speech interface, voice commands for operating devices by voice are typically predetermined, so that a user can operate the devices easily by the predetermined voice commands. However, such a speech interface has a problem that the user has to remember the predetermined voice commands.

JP-A 2003-241709 (KOKAI) discloses a computer apparatus. The computer apparatus expects a case where a user does not remember voice commands correctly. In the computer apparatus, when it recognizes a voice command, it compares the voice command to registered commands, and if the voice command does not match any of the registered commands, it interprets the voice command through dictation as a sentence, and determines degree of similarity between the sentence and the registered commands.

Information Processing Society of Japan 117th Human Interface Research Group Report, 2006-H1-117, 2006: “Research on a practical home robot interface by introducing friendly operations <an interface being operated and doing notification with user's words>”, discloses an interface apparatus that allows a user to operate a device with free words instead of predetermined voice commands.

As outlined above, there has recently been a need for a user-friendly interface that serves as an intermediary between an information appliance and a user and allows every user to operate a device (information appliance) and to understand device information easily. To realize such a user-friendly interface, it is desirable that the user does not have to intentionally remember how to operate the device and that the user can operate the device and receive the device information naturally. Further, it would be convenient if the user could instruct the interface about operation of the device, not by mechanical means such as a keyboard and a mouse, but by physical means such as voice and gestures. However, automatic recognition techniques for voice and gestures have a problem of frequent occurrence of misrecognition, so that the user might be required to do the same instructing operation a number of times until the misrecognition is solved, which might frustrate the user.

### SUMMARY OF THE INVENTION

An embodiment of the present invention is, for example, an interface apparatus configured to perform a device operation in response to a voice instruction from a user, including:

a state detection section configured to detect a state change or state continuation of a device or the vicinity of the device;

a query section configured to query a user by voice about the meaning of the detected state change or state continuation;

a speech recognition control section configured to have one or more speech recognition units recognize a teaching speech uttered by the user in response to the query and an instructing speech uttered by a user for a device operation, the one or more speech recognition units being configured to recognize the teaching speech and the instructing speech;

an accumulation section configured to associate a recognition result for the teaching speech with a detection result for the state change or state continuation, and accumulate a correspondence between the recognition result for the teaching speech and the detection result for the state change or state continuation;

a comparison section configured to compare a recognition result for the instructing speech with accumulated correspondences between recognition results for teaching speeches and detection results for state changes or state continuations, and select a device operation specified by a detection result for a state change or state continuation that corresponds to the recognition result for the instructing speech; and

a device operation section configured to perform the selected device operation.

Another embodiment of the present invention is, for example, an interface apparatus configured to notify device information to a user by voice, including:

a state detection section configured to detect a state change or state continuation of a device or the vicinity of the device;

a query section configured to query a user by voice about the meaning of the detected state change or state continuation;

a speech recognition control section configured to have a speech recognition unit recognize a teaching speech uttered by the user in response to the query, the speech recognition unit being configured to recognize the teaching speech;

an accumulation section configured to associate a detection result for the state change or state continuation with a recognition result for the teaching speech, and accumulate a correspondence between the detection result for the state change or state continuation and the recognition result for the teaching speech;

a comparison section configured to compare a detection result for a newly detected state change or state continuation with accumulated correspondences between detection results for state changes or state continuations and recognition results for teaching speeches, and select a notification word that corresponds to the detection result for the newly detected state change or state continuation; and

a notification section configured to notify device information to a user by voice, by converting the selected notification word into sound.

Another embodiment of the present invention is, for example, an interface processing method of performing a device operation in response to a voice instruction from a user, including:

detecting a state change or state continuation of a device or the vicinity of the device;

querying a user by voice about the meaning of the detected state change or state continuation;

having a speech recognition unit recognize a teaching speech uttered by the user in response to the query, the speech recognition unit being configured to recognize the teaching speech;

associating a recognition result for the teaching speech with a detection result for the state change or state continuation, and accumulating a correspondence between the recognition result for the teaching speech and the detection result for the state change or state continuation;

having a speech recognition unit recognize an instructing speech uttered by a user for a device operation, the speech recognition unit being configured to recognize the instructing speech;

comparing a recognition result for the instructing speech with accumulated correspondences between recognition results for teaching speeches and detection results for state changes or state continuations, and selecting a device operation specified by a detection result for a state change or state continuation that corresponds to the recognition result for the instructing speech; and

performing the selected device operation.

Another embodiment of the present invention is, for example, an interface processing method of notifying device information to a user by voice, including:

detecting a state change or state continuation of a device or the vicinity of the device;

querying a user by voice about the meaning of the detected state change or state continuation;

having a speech recognition unit recognize a teaching speech uttered by the user in response to the query, the speech recognition unit being configured to recognize the teaching speech;

associating a detection result for the state change or state continuation with a recognition result for the teaching speech, and accumulating a correspondence between the detection result for the state change or state continuation and the recognition result for the teaching speech;

comparing a detection result for a newly detected state change or state continuation with accumulated correspondences between detection results for state changes or state continuations and recognition results for teaching speeches, and selecting a notification word that corresponds to the detection result for the newly detected state change or state continuation; and

notifying device information to a user by voice, by converting the selected notification word into sound.

Another embodiment of the present invention is, for example, an interface processing program of having a computer perform an information processing method of performing a device operation in response to a voice instruction from a user, the method including:

detecting a state change or state continuation of a device or the vicinity of the device;

querying a user by voice about the meaning of the detected state change or state continuation;

having a speech recognition unit recognize a teaching speech uttered by the user in response to the query, the speech recognition unit being configured to recognize the teaching speech;

associating a recognition result for the teaching speech with a detection result for the state change or state continuation, and accumulating a correspondence between the recognition result for the teaching speech and the detection result for the state change or state continuation;

having a speech recognition unit recognize an instructing speech uttered by a user for a device operation, the speech recognition unit being configured to recognize the instructing speech;

comparing a recognition result for the instructing speech with accumulated correspondences between recognition results for teaching speeches and detection results for state changes or state continuations, and selecting a device operation specified by a detection result for a state change or state continuation that corresponds to the recognition result for the instructing speech; and

performing the selected device operation.

Another embodiment of the present invention is, for example, an interface processing program of having a computer perform an information processing method of notifying device information to a user by voice, the method including:

detecting a state change or state continuation of a device or the vicinity of the device;

querying a user by voice about the meaning of the detected state change or state continuation;

having a speech recognition unit recognize a teaching speech uttered by the user in response to the query, the speech recognition unit being configured to recognize the teaching speech;

associating a detection result for the state change or state continuation with a recognition result for the teaching speech, and accumulating a correspondence between the detection result for the state change or state continuation and the recognition result for the teaching speech;

comparing a detection result for a newly detected state change or state continuation with accumulated correspondences between detection results for state changes or state continuations and recognition results for teaching speeches, and selecting a notification word that corresponds to the detection result for the newly detected state change or state continuation; and

notifying device information to a user by voice, by converting the selected notification word into sound.

### BRIEF DESCRIPTION OF THE DRAWINGS

FIG. 1 illustrates an interface apparatus of the first embodiment;

FIG. 2 is a flowchart showing the operations of the interface apparatus of the first embodiment;

FIG. 3 illustrates the interface apparatus of the first embodiment;

FIG. 4 is a block diagram showing the configuration of the interface apparatus of the first embodiment;

FIG. 5 illustrates an interface apparatus of the second embodiment;

FIG. 6 is a flowchart showing the operations of the interface apparatus of the second embodiment;

FIG. 7 is a block diagram showing the configuration of the interface apparatus of the second embodiment;

FIG. 8 is a block diagram showing the configuration of the interface apparatus of the third embodiment;

FIG. 9 illustrates the fourth embodiment;

FIG. 10 is a block diagram showing the configuration of the interface apparatus of the fourth embodiment;

FIG. 11 illustrates the fifth embodiment; and

FIG. 12 illustrates an interface processing program.

### DETAILED DESCRIPTION OF THE INVENTION

This specification is written in English, while the specification of the prior Japanese Patent Application No. 2006-233468 is written in Japanese. Embodiments described below relate to a speech processing technique, and contents of this specification originally relate to speeches in Japanese, so Japanese words are expressed in this specification as necessary. The speech processing technique of embodiments described below is applicable to English, Japanese, and other languages as well.

### First Embodiment

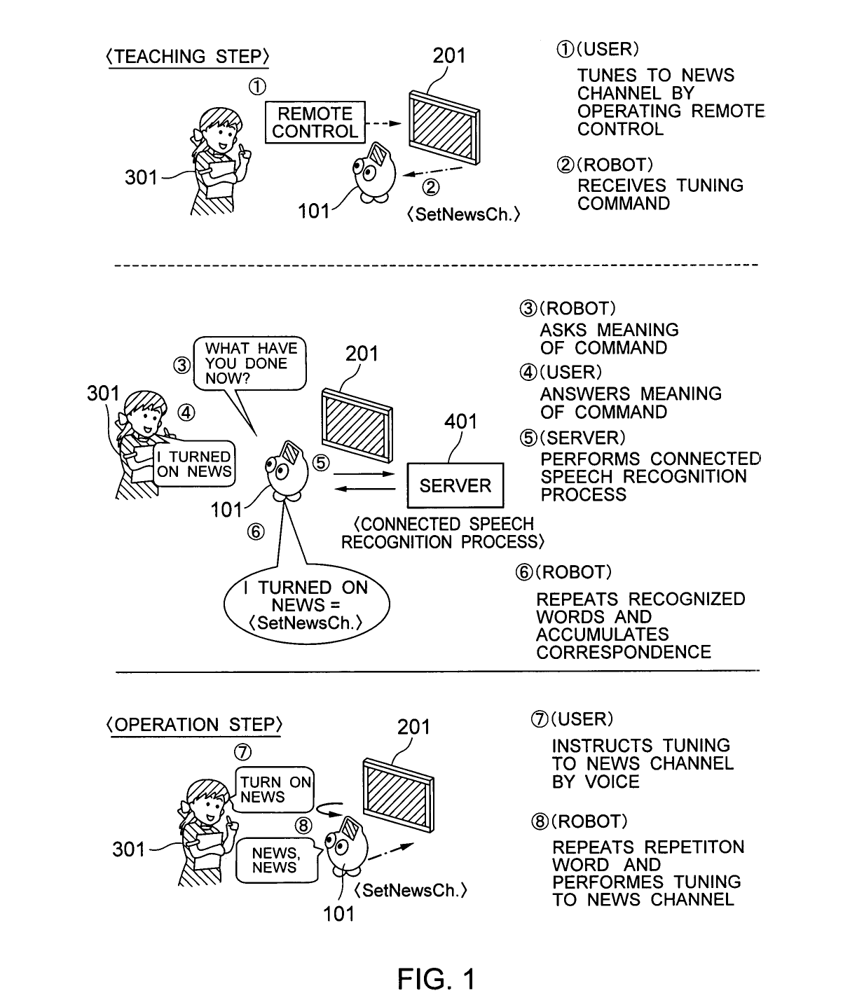

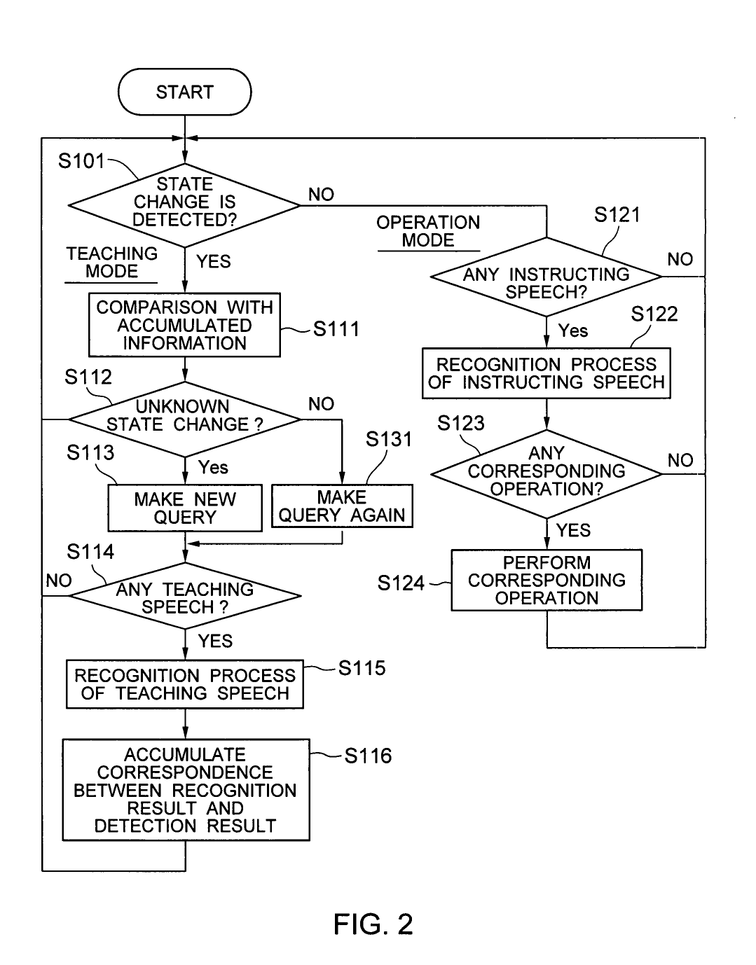

FIG. 1 illustrates an interface apparatus 101 of the first embodiment. The interface apparatus 101 is a robot-shaped interface apparatus having friendly-looking physicality. The interface apparatus 101 is a speech interface apparatus, which has voice input function and voice output function. The following description illustrates, as a device, a television 201 for multi-channel era, and describes a device operation for tuning the television 201 to a news channel. In the following description, there are indicated the correspondences between operations of the interface apparatus 101 shown in FIG. 1 and step numbers of the flowchart shown in FIG. 2. FIG. 2 is a flowchart showing the operations of the interface apparatus 101 of the first embodiment.

Actions of a user 301 who uses the interface apparatus 101 of FIG. 1 can be classified into “teaching step” for performing a voice teaching and “operation step” for performing a voice operation.

At the teaching step, the user 301 operates a remote control with his/her hand to tune the television 201 to the news channel. At this time, the interface apparatus 101 receives a remote control signal associated with the tuning operation. Thereby, the interface apparatus 101 detects a state change of the television 201 such that the television 201 was operated (S101). If the television 201 is connected to a network, the interface apparatus 101 receives the remote control signal from the television 201 via the network, and if the television 201 is not connected to a network, the interface apparatus 101 receives the remote control signal directly from the remote control.

Then, the interface apparatus 101 compares the command of the remote control signal (with regard to a networked appliance, a switching command <SetNewsCh>, and with regard to a non-networked appliance, the signal code itself) against accumulated commands (S111). If the command of the remote control signal is an unknown command (S112), the interface apparatus 101 queries (asks) the user 301 about the meaning of the command of the remote control signal, that is, the meaning of the detected state change, by speaking “What have you done now?” by voice (S113). If the user 301 answers “I turned on news” within a certain time period in response to the query (S114), the interface apparatus 101 has a speech recognition unit perform a speech recognition process of the teaching speech “I turned on news” uttered by the user 301 (S115). In other words, the interface apparatus 101 controls the speech recognition unit so that the speech recognition unit performs the speech recognition process. The speech recognition unit is configured to perform the speech recognition process. The speech recognition unit is, for example, a speech recognition device or program provided inside or outside the interface apparatus 101. In this embodiment, a server 401 for connected speech recognition is provided outside the interface apparatus 101, and the interface apparatus 101 has the server 401 perform the speech recognition process. Subsequently, the interface apparatus 101 obtains a recognition result for the teaching speech recognized by connected speech recognition, from the server 401. Then, the interface apparatus 101 repeats the recognized words “I turned on news” which are the recognition result for the teaching speech, and associates the recognition result for the teaching speech with a detection result for the state change, and accumulates a correspondence between the recognition result for the teaching speech and the detection result for the state change, in a storage device such as an HDD (S116). Specifically, the correspondence between the recognized words “I turned on news” and the detected command <SetNewsCh> is accumulated in a storage device such as an HDD.

At the operation step, when the user 301 says “Turn on news” for tuning the television 201 to the news channel (S121), the interface apparatus 101 has a speech recognition unit perform a speech recognition process of the instructing speech “Turn on news” uttered by the user 301 (S122). In other words, the interface apparatus 101 controls the speech recognition unit so that the speech recognition unit performs the speech recognition process. The speech recognition unit is configured to perform the speech recognition process. The speech recognition unit is, for example, a speech recognition device or program provided inside or outside the interface apparatus 101. In this embodiment, the interface apparatus 101 has the server 401 perform the speech recognition process. Subsequently, the interface apparatus 101 obtains a recognition result for the instructing speech recognized by connected speech recognition, from the server 401. Then, the interface apparatus 101 compares the recognition result for the instructing speech with accumulated correspondences between recognition results for teaching speeches and detection results for state changes, and selects a device operation specified by a detection result for a state change or state continuation that corresponds to the recognition result for the instructing speech (S123). Specifically, the teaching speech “I turned on news” is hit as a teaching speech corresponding to the instructing speech “Turn on news”, so that the command <SetNewsCh> corresponding to the teaching speech “I turned on news” is selected as a command corresponding to the instructing speech “Turn on news”. Then, the interface apparatus 101 repeats a repetition word “news” which is a word corresponding to the recognition result for the instructing speech again and again, and performs the selected device operation (S124). Specifically, the network command <SetNewsCh> is transmitted via a network (or an equivalent remote control signal is transmitted by the interface apparatus 101), so that the television 201 is tuned to the news channel.

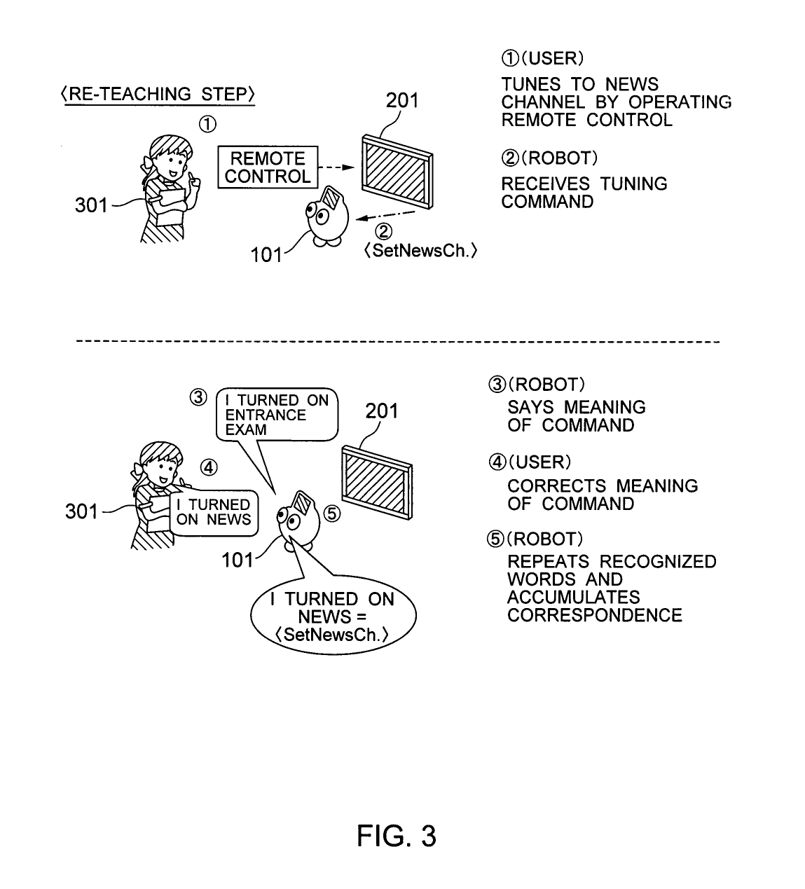

At the teaching step, the teaching speech “I turned on news” can be misrecognized. For example, if the teaching speech “I turned on news (in Japanese ‘nyusu tsuketa’)” is misrecognized as “I turned on entrance exam (in Japanese ‘nyushi tsuketa’)” (S115), the interface apparatus 101 repeats the recognition result for the teaching speech “I turned on entrance exam” (S116). Hearing it, the user 301 easily understands that the teaching speech “I turned on news” was misrecognized as “I turned on entrance exam”. Thus, the user 301 repeats the teaching speech “I turned on news” to teach it again. On the other hand, if the user 301 does not repeat the teaching speech “I turned on news” and subsequently tunes the television 201 to the news channel again, in a case that learning has not advanced, the interface apparatus 101 queries (asks) the user 301 about the meaning of the state change detected again, by speaking “What have you done now?” by voice, and in a case that learning has advanced, the interface apparatus 101 says the words “I turned on entrance exam” which it has already learned (S131). By responding to the query in the former case, and by correcting the mistake in the latter case, the user 301 re-teaches the teaching speech “I turned on news”. This is illustrated in FIG. 3.

As described above, the first embodiment provides a user-friendly speech interface that serves as an intermediary between a device and a user and allows the user to operate the device easily. In the first embodiment, since a speech recognition process in a voice operation is performed by utilizing a speech recognition result in a voice teaching, the user is not required to use predetermined voice commands. In addition, in the first embodiment, since a voice teaching is performed in response to a query asking the meaning of a device operation (e.g. tuning to a news channel), words which are natural as the words for a voice operation (such as “news” and “turn on”) are naturally used in a teaching speech. Thus, if the user says a natural phrase to perform a voice operation, in many cases the words in the phrase will have been already registered as the words for the voice operation, so that the words in the phrase will function as the words for the voice operation. Thereby, the user is freed from excessive burden of intentionally remembering a large number of words for voice operations. Further, since a voice teaching is requested in the form of a query, the user can easily understand what to teach; if the user is asked “What have you done now?”, the user only has to answer what he/she has done now.

Furthermore, in the first embodiment, since the meaning of a device operation is asked by voice, a voice teaching from a user is easy to obtain. This is because the user can easily know that he/she is being asked something. Particularly, in the first embodiment, since the voice teaching is requested by a query which is easy to understand, it is considered to be desirable that the voice teaching be requested by voice which is easy to perceive. When the interface apparatus repeats a recognized word(s) for a teaching speech, or repeats a repetition word(s) for an instructing speech, or makes a query, it may repeat the same matter again and again like an infant, or may speak the word(s) as a question with rising intonation. Such friendly operation gives the user sense of affinity and facilitates the user's response.

In the first embodiment, the interface apparatus 101 determines whether or not there is a correspondence between the teaching speech “I turned on news: nyusu tuketa” and the instructing speech “Turn on news: nyusu tukete” which are partially different, and as a result, it is determined that they correspond to each other (S123). Such comparison process is realized herein by calculating and analyzing degree of agreement at morpheme level, between the result of connected speech recognition for the teaching speech and the result of connected speech recognition for the instructing speech. Specific examples of this comparison process will be shown in the fourth embodiment.

While this embodiment illustrates a case where one interface apparatus handles one device, the embodiment is also applicable to a case where one interface apparatus handles two or more devices. In that case, the interface apparatus handles, for example, not only teaching and instructing speeches for identifying device operations, but also teaching and instructing speeches for identifying target devices. The devices can be identified, for example, by utilizing identification information of the devices (e.g. device name or device ID).

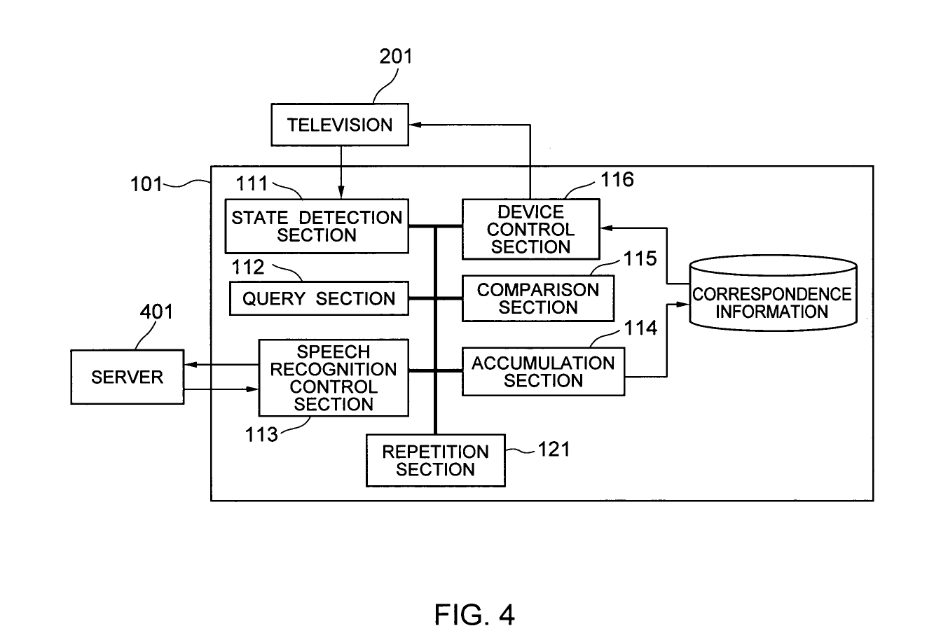

FIG. 4 is a block diagram showing the configuration of the interface apparatus 101 of the first embodiment.

The interface apparatus 101 of the first embodiment includes a state detection section 111, a query section 112, a speech recognition control section 113, an accumulation section 114, a comparison section 115, a device operation section 116, and a repetition section 121. The server 401 is an example of a speech recognition unit.

The state detection section 111 is a block that performs the state detection process at S101. The query section 112 is a block that performs the query processes at S113 and S131. The speech recognition control section 113 is a block that performs the speech recognition control processes at S115 and S122. The accumulation section 114 is a block that performs the accumulation process at S116. The comparison section 115 is a block that performs the comparison processes at S111 and S123. The device operation section 116 is a block that performs the device operation process at S124. The repetition section 121 is a block that performs the repetition processes at S116 and S124.

### Second Embodiment

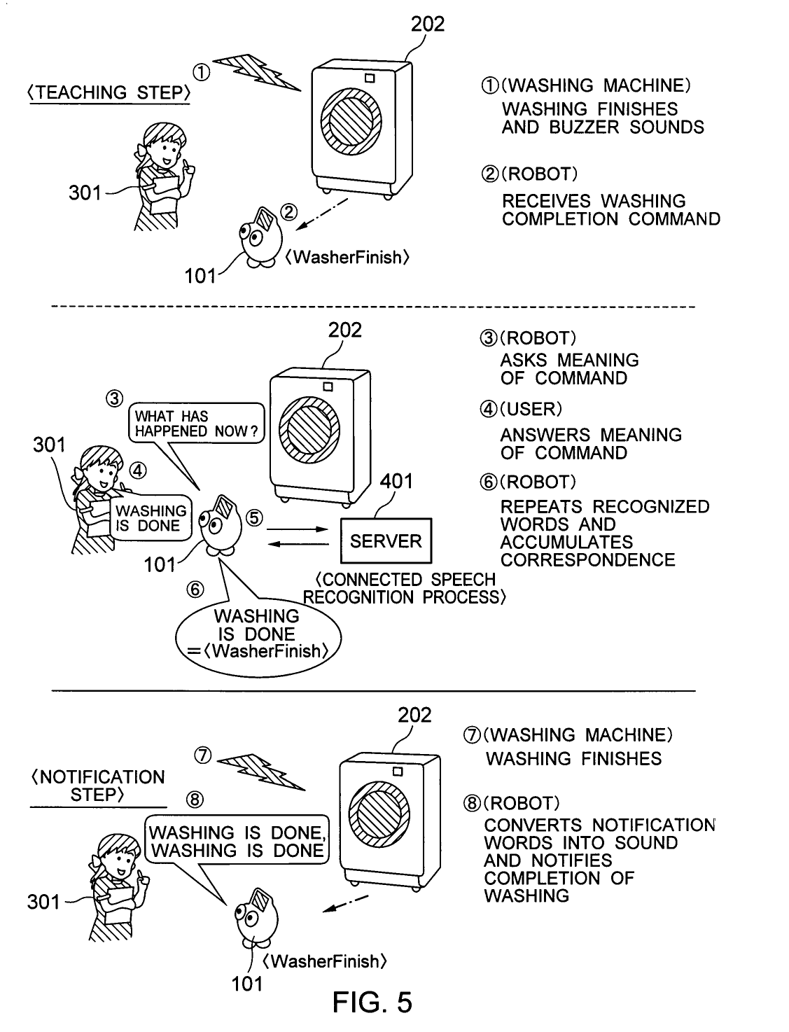

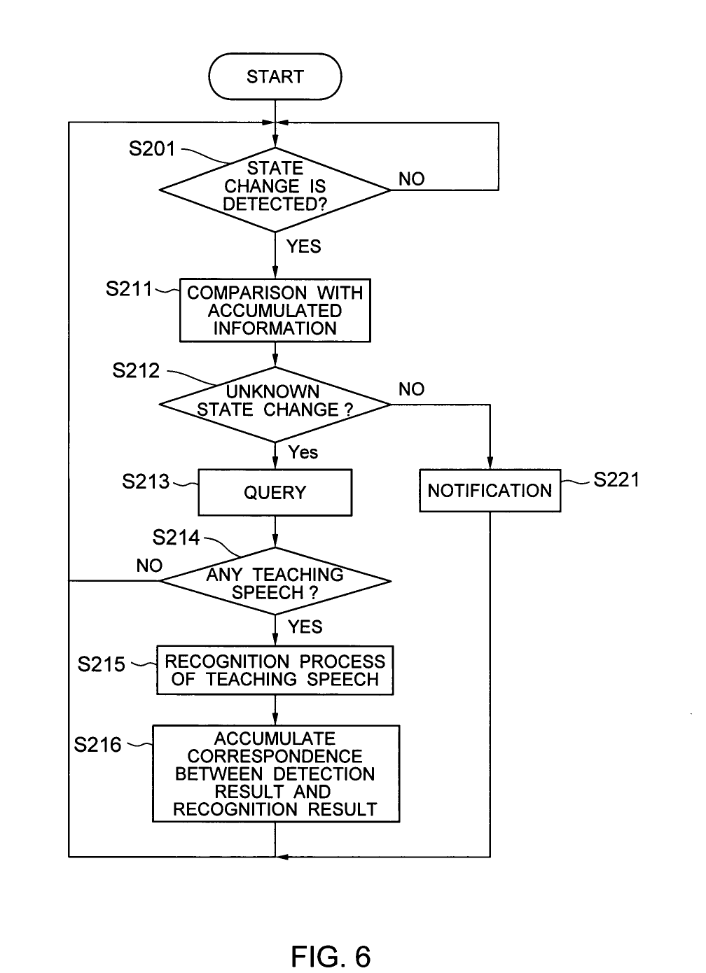

FIG. 5 illustrates an interface apparatus 101 of the second embodiment. The second embodiment is a variation of the first embodiment and will be described mainly focusing on its differences from the first embodiment. The following description illustrates, as a device, a washing machine 202 designed as an information appliance, and describes a notification method of providing a user 301 with device information of the washing machine 202 such as completion of washing. In the following description, there are indicated the correspondences between operations of the interface apparatus 101 shown in FIG. 5 and step numbers of the flowchart shown in FIG. 6. FIG. 6 is a flowchart showing the operations of the interface apparatus 101 of the second embodiment.

Actions of the user 301 who uses the interface apparatus 101 of FIG. 5 can be classified into “teaching step” for performing a voice teaching and “notification step” for receiving a voice notification.

At the teaching step, the interface apparatus 101 first receives a notification signal associated with completion of washing from the washing machine 202. Thereby, the interface apparatus 101 detects a state change of the washing machine 202 such that an event occurred on the washing machine 202 (S201). If the washing machine 202 is connected to a network, the interface apparatus 101 receives the notification signal from the washing machine 202 via the network, and if the washing machine 202 is not connected to a network, the interface apparatus 101 receives the notification signal directly from the washing machine 202.

Then, the interface apparatus 101 compares the command of the notification signal (with regard to a networked appliance, a washing completion command <WasherFinish>, and with regard to a non-networked appliance, the signal code itself) against accumulated commands (S211). If the command of the notification signal is an unknown command (S212), the interface apparatus 101 queries (asks) the user 301 about the meaning of the command of the notification signal, that is, the meaning of the detected state change, by speaking “What has happened now?” by voice (S213). If the user 301 answers “Washing is done” within a certain time period in response to the query (S214), the interface apparatus 101 has a speech recognition unit perform a speech recognition process of the teaching speech “Washing is done” uttered by the user 301 (S215). In other words, the interface apparatus 101 controls the speech recognition unit so that the speech recognition unit performs the speech recognition process. The speech recognition unit is configured to perform the speech recognition process. The speech recognition unit is, for example, a speech recognition device or program provided inside or outside the interface apparatus 101. In this embodiment, a server 401 for connected speech recognition is provided outside the interface apparatus 101, and the interface apparatus 101 has the server 401 perform the speech recognition process. Subsequently, the interface apparatus 101 obtains a recognition result for the teaching speech recognized by connected speech recognition, from the server 401. Then, the interface apparatus 101 repeats the recognized words “Washing is done” which are the recognition result for the teaching speech, and associates a detection result for the state change with the recognition result for the teaching speech, and accumulates a correspondence between the detection result for the state change and the recognition result for the teaching speech, in a storage device such as an HDD (S216). Specifically, the correspondence between the detected command <WasherFinish> and the recognized words “Washing is done” is accumulated in a storage device such as an HDD.

At the notification step, the interface apparatus 101 first newly receives a notification signal associated with completion of washing from the washing machine 202. Thereby, the interface apparatus 101 newly detects a state change of the washing machine 202 such that an event occurred on the washing machine 202 (S201).

Then, the interface apparatus 101 compares a detection result for the newly detected state change with accumulated correspondences between detection results for state changes and recognition results for teaching speeches, and selects notification words that correspond to the detection result for the newly detected state change (S211 and S212). Specifically, the accumulated command <WasherFinish> is hit as a command corresponding to the detected command <WasherFinish>, so that the teaching speech “Washing is done” corresponding to the accumulated command <WasherFinish> is selected as notification words corresponding to the detected command <WasherFinish>. Although the notification word(s) are the teaching speech “Washing is done” itself here, the notification word(s) may be, for example, the word(s) extracted from the teaching speech such as “Done”, or the word(s) generated from the teaching speech such as “Washing has been done”. Then, the interface apparatus 101 notifies (provides) device information to the user 301 by voice, by converting the notification words into sound (S221). Specifically, device information of the washing machine 202 such as completion of washing is notified (provided) to the user 301 by voice, by converting the notification words “Washing is done” into sound. In this embodiment, the notification words “Washing is done” are converted into sound and spoken repeatedly.

As described above, the second embodiment provides a user-friendly speech interface that serves as an intermediary between a device and a user and allows the user to understand device information easily. In this embodiment, since device information is provided by voice, the user can easily understand device information. For example, if device information such as completion of washing is provided with a buzzer, there would be a problem that the device information cannot be distinguished from other device information if such device information is also provided with a buzzer. Furthermore, in this embodiment, since a notification word(s) in voice notification is set by utilizing a speech recognition result in a voice teaching, a word(s) that facilitates understanding of device information is set as a notification word(s). Particularly, in this embodiment, since a voice teaching is performed in response to a query asking the meaning of an occurring event (e.g. completion of washing), words which are natural as the words for a voice notification (such as “washing” and “done”) are naturally used in a teaching speech. Thus, a word(s) that allows the user to understand device information quite naturally are set as a notification word(s). Further, since a voice teaching is requested in the form of a query, the user can easily understand what to teach: if the user is asked “What has happened now?”, the user only has to answer what has happened now.

While the first embodiment describes the interface apparatus that supports voice teaching and voice operation and the second embodiments describes the interface apparatus that supports voice teaching and voice notification, it is also possible to realize an interface apparatus that supports voice teaching, voice operations, and voice notification as a variation of these embodiments.

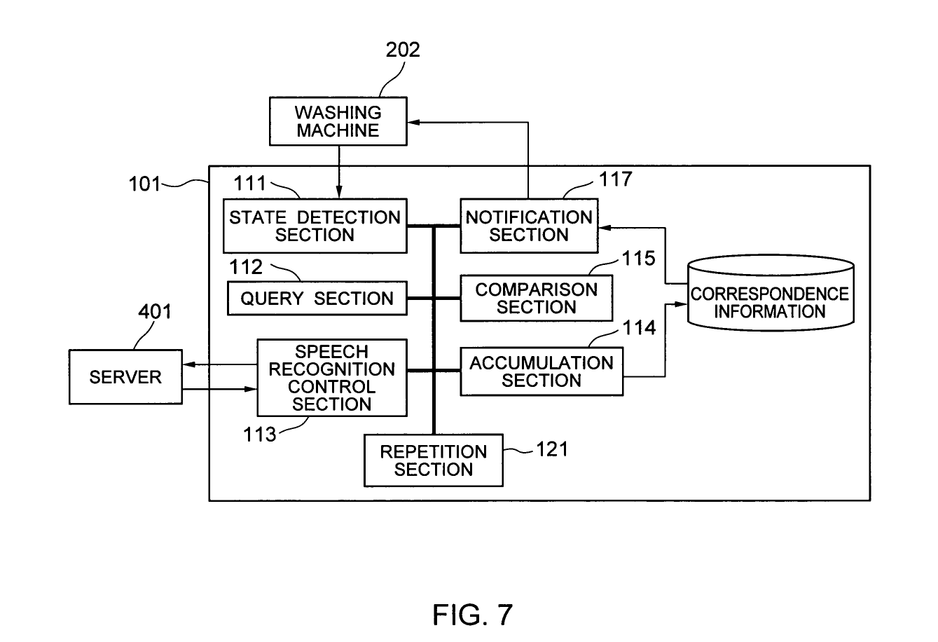

FIG. 7 is a block diagram showing the configuration of the interface apparatus 101 of the second embodiment.

The interface apparatus 101 of the second embodiment includes a state detection section 111, a query section 112, a. speech recognition control section 113, an accumulation section 114s, a comparison section 115, a notification section 117, and a repetition section 121. The server 401 is an example of a speech recognition unit.

The state detection section 111 is a block that performs the state detection process at S201. The query section 112 is a block that performs the query process at S213. The speech recognition control section 113 is a block that performs the speech recognition control process at S215. The accumulation section 114 is a block that performs the accumulation process at S216. The comparison section 115 is a block that performs the comparison processes at S211 and S212. The notification section 117 is a block that performs the notification process at S221. The repetition section 121 is a block that performs the repetition process at S216.

### Third Embodiment

With reference to FIGS. 1 and 2, an interface apparatus 101 of the third embodiment will be described. The third embodiment is a variation of the first embodiment and will be described mainly focusing on its differences from the first embodiment. The following description illustrates, as a device, a television 201 for multi-channel era, and describes a device operation for tuning the television 201 to a news channel.

At S115 in the teaching step, the interface apparatus 101 has a speech recognition unit for connected speech recognition perform a speech recognition process of a teaching speech “I turned on news” uttered by the user 301. In other words, the interface apparatus 101 controls the speech recognition unit so that the speech recognition unit performs the speech recognition process. The speech recognition unit is configured to perform the speech recognition process. The speech recognition unit is, for example, a speech recognition device or program for connected speech recognition provided inside or outside the interface apparatus 101. In this embodiment, a server 401 for connected speech recognition is provided outside the interface apparatus 101, and the interface apparatus 101 has the server 401 perform the speech recognition process Subsequently, the interface apparatus 101 obtains a recognition result for the teaching speech recognized by connected speech recognition, from the server 401. Then, the interface apparatus 101 repeats the recognized words “I turned on news” which are the recognition result for the teaching speech recognized by connected speech recognition, and associates the recognition result for the teaching speech with a detection result for the state change, and accumulates a correspondence between the recognition result for the teaching speech and the detection result for the state change, in a storage device such as an HDD (S116). Specifically, the correspondence between the recognized words “I turned on news” and the detected command <SetNewsCh> is accumulated in a storage device such as an HDD.

At S116 in the teaching step, the interface apparatus 101 further analyzes the recognition result for the teaching speech, and obtains a morpheme “news” from the recognized words “I turned on news” which are the recognition result for the teaching speech (analysis process). The interface apparatus 101 further registers the obtained morpheme “news” in a storage device such as an HDD, as a standby word for recognizing an instructing speech by isolated word recognition (registration process). In this embodiment, although the standby word is a word obtained from the recognized words, the standby word may be a phrase or a collocation obtained from the recognized words, or a part of a word obtained from the recognized words. The interface apparatus 101 accumulates the standby word in a storage device such as an HDD, being associated with the recognition result for the teaching speech and the detection result of the state change.

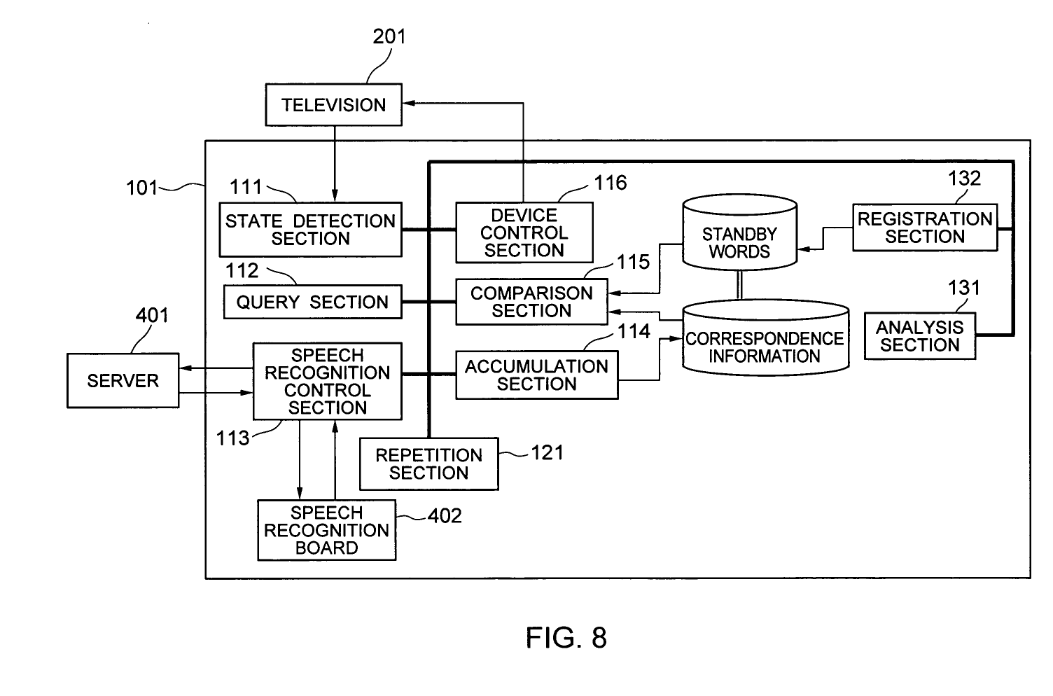

At S122 in the operation step, the interface apparatus; 101 has a speech recognition unit for isolated word recognition perform a speech recognition process of an instructing speech “Turn on news” uttered by the user 301. In other words, the interface apparatus 101 controls the speech recognition unit so that the speech recognition unit performs the speech recognition process. The speech recognition unit is configured to perform the speech recognition process. The speech recognition unit is, for example, a speech recognition device or program for isolated word recognition provided inside or outside the interface apparatus 101. In this embodiment, a speech recognition board 402 for isolated word recognition is provided inside the interface apparatus 101 (FIG. 8), and the interface apparatus 101 has the speech recognition board 402 perform the speech recognition process. The speech recognition board 402 recognizes the instructing speech by comparing it with registered standby words. As a result, it is found that the standby word “news” is contained in the instructing speech. Then, the interface apparatus 101 obtains a recognition result for the instructing speech recognized by isolated word recognition, from the speech recognition board 402. Then, the interface apparatus 101 compares the recognition result for the instructing speech with accumulated correspondences between recognition results for teaching speeches and detection results for state changes or state continuations, and selects a device operation specified by a detection result for a state change or state continuation that corresponds to the recognition result for the instructing speech (S123). Specifically, the teaching-speech recognition result “I turned on news” or “News” is hit as a teaching-speech recognition result corresponding to the instructing-speech recognition result “News”, so that the command <SetNewsCh> is selected as a command corresponding to the instructing-speech recognition result “News”. The teaching-speech recognition result which is referred in the comparison process may be the connected speech recognition result “I turned on news”, or may be the standby word “News” which is obtained from the connected speech recognition result “I turned on news”. Then, the interface apparatus 101 repeats the recognized word “news” which is the recognition result of the instructing speech again and again, as a repetition word corresponding to the recognition result of the instructing speech, and performs the selected device operation (S124). Specifically, the command <SetNewsCh> of the remote control signal is executed, so that the television 201 is tuned to the news channel.

Here, connected speech recognition and isolated word recognition will be compared. Connected speech recognition has an advantage that it can handle much more words than isolated word recognition, so that it allows a user to speak with very high degree of freedom. On the other hand, connected speech recognition has a disadvantage that it produces much processing burden and requires a large amount of memory, so that it requires much electrical power and costs.

In the third embodiment, a speech recognition process of a teaching speech is performed by connected speech recognition, and a speech recognition process of an instructing speech is performed by isolated word recognition. Although this increases processing burden of a teaching-speech recognition process, processing burden of an instructing-speech recognition process is significantly reduced. On the other hand, with regard to the user 301 who purchased the interface apparatus 101 and the television 201, in general, voice teachings occur frequently only immediately after the purchase, and voice operations are repeated continuously after the purchase. In this way, in general, the frequency of occurrence of teaching-speech recognition processes is much less than that of instructing-speech recognition processes. Therefore, if processing burden of instructing-speech recognition processes is largely reduced, electrical power and costs required for the entire interface apparatus or system are significantly reduced. This is a reason why teaching-speech recognition processes and instructing-speech recognition processes are performed by connected speech recognition and isolated word recognition respectively in the third embodiment. In addition, in the third embodiment, by performing instructing-speech recognition processes by isolated word recognition, a high recognition rate for instructing speeches is achieved, compared to performing instructing-speech recognition processes by connected speech recognition.

In the third embodiment, by performing teaching-speech recognition processes by connected speech recognition, it is allowed to obtain standby words from teaching-speech recognition results and hence to perform instructing-speech recognition processes by isolated word recognition.

In the third embodiment, for reasons of burden and frequency of processing, speech recognition processes of teaching speeches by connected speech recognition are preferred to be performed by a speech recognition unit provided outside the interface apparatus 101, and speech recognition processes of instructing speeches by isolated word recognition are preferred to be performed by a speech recognition unit provided inside the interface apparatus 101.

FIG. 8 is a block diagram showing the configuration of the interface apparatus 101 of the third embodiment.

The interface apparatus 101 of the third embodiment includes a state detection section 111, a query section 112, a speech recognition control section 113, an accumulation section 114, a comparison section 115, a device operation section 116, a repetition section 121, an analysis section 131, and a registration section 132. The server 401 is an example of a speech recognition unit provided outside the interface apparatus 101, and the speech recognition board 402 is an example of a speech recognition unit provided inside the interface apparatus 101.

The state detection section 111 is a block that performs the state detection process at S101. The query section 112 is a block that performs the query processes at S113 and S131. The speech recognition control section 113 is a block that performs the speech recognition control processes at S115 and S122. The accumulation section 114 is a block that performs the accumulation process at S116. The comparison section 115 is a block that performs the comparison processes at S111 and S123. The device operation section 116 is a block that performs the device operation process at S124. The repetition section 121 is a block that performs the repetition processes at S116 and S124. The analysis section 131 is a block that performs the analysis process at S116. The registration section 132 is a block that performs the registration process at S116.

### Fourth Embodiment

With reference to FIGS. 1 and 2, an interface apparatus 101 of the fourth embodiment will be described. The fourth embodiment is a variation of the third embodiment and will be described mainly focusing on its differences from the third embodiment. The following description illustrates, as a device, a television 201 for multi-channel era, and describes a device operation for tuning the television 201 to a news channel.

At S116 in the third embodiment, the interface apparatus 101 analyzes the teaching-speech recognition result “I turned on news”, and obtains a morpheme “news” from it (analysis process). The teaching-speech recognition result “I turned on news” is a recognition result by connected speech recognition. At S116 in the third embodiment, the interface apparatus 101 further registers the obtained morpheme “news” in a storage device, as a standby word for recognizing an instructing speech by isolated word recognition (registration process). Before the registration process, the interface apparatus 101 selects a morpheme to be a standby word (“news” in this example), from one or more morphemes obtained from the teaching-speech recognition result “I turned on news” (selection process). The fourth embodiment illustrates this selection process.

For example, when a sufficient number of standby words have not been registered yet, the interface apparatus 101 of the fourth embodiment is placed in “standby-off state”, in which an instructing-speech recognition process is performed without using a standby word, and an instructing-speech recognition process is performed by a speech recognition unit for connected speech recognition. For example, when a sufficient number of standby words have been already registered, the interface apparatus 101 of the fourth embodiment is placed in “standby-on state”, in which an instructing-speech recognition process is performed using a standby word, and an instructing-speech recognition process is performed by a speech recognition unit for isolated word recognition. In standby-off state, the interface apparatus 101 performs speech recognition control and comparison processes for instructing speeches in similar ways to S122 and S123 of the first embodiment. In standby-on state, the interface apparatus 101 performs speech recognition control and comparison processes for instructing speeches in similar ways to S122 and S123 of the third embodiment. For example, the interface apparatus 101 switches from standby-off state to standby-on state when the number of registered words has exceeded a predetermined number, and switches from standby-on state to standby-off state again when recognition rate for instructing speeches has fallen below a predetermined value.

The following will describe the operations of the interface apparatus 101 in standby-off state, and subsequently will describe a selection process for selecting a morpheme to be a standby word. In standby-off state, both of a teaching-speech recognition process and an instructing-speech recognition process are performed by connected speech recognition.

At S116 in the teaching step, the interface apparatus 101 separates the teaching-speech recognition result “I turned on news” into one or more morphemes based on the analysis result for it. In this example, the teaching-speech recognition result “I turned on news: nyusu tsuketa” is separated into three morphemes “nyusu”, “tsuke”, and “ta”. Then, the obtained morphemes “nyusu”, “tsuke”, and “ta” are accumulated in a storage device, being associated with the teaching-speech recognition result “I turned on news” and the state-change detection result <SetNewsCh>.

At S123 in the operation step, the interface apparatus 101 separates the instructing-speech recognition result “Turn on news” into one or more morphemes based on the analysis result for it. In this example, the instructing-speech recognition result “Turn on news: nyusu tsukete” is separated into three morphemes “nyusu”, “tsuke”, and “te”. Then, the interface apparatus 101 compares the instructing-speech recognition result with accumulated correspondences between teaching-speech recognition results and state-change detection results, and selects a device operation that corresponds to the instructing-speech recognition result. In this comparison process, it is determined whether there is a correspondence between a teaching-speech recognition result and an instructing-speech recognition result, based on degree of agreement between them at morpheme level.

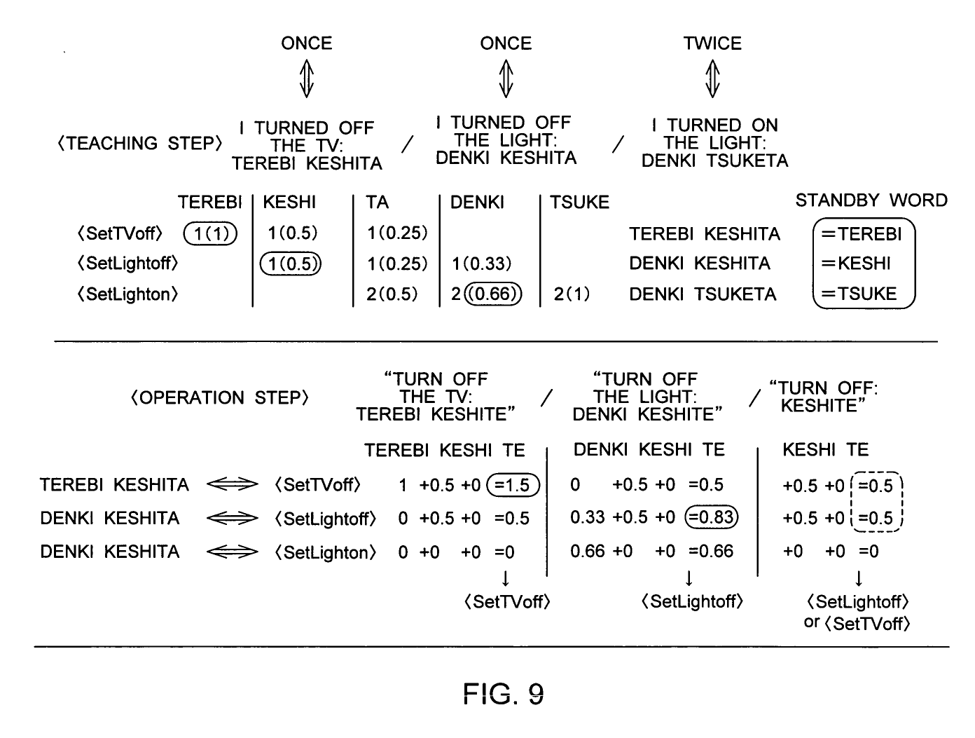

In this embodiment, degree of agreement between them at morpheme level, is calculated based on statistical data about teaching speeches inputted into the interface apparatus 101. As a example, it will be described how to calculate the degree of agreement, for a case where a teaching speech “I turned off TV” has been inputted once, a teaching speech “I turned off the light” has been inputted once, and a teaching speech “I turned on the light” has been inputted twice, into the interface apparatus 101 so far. FIG. 9 illustrates the way of calculating the degree of agreement in this case.

At S116 in the teaching step, the teaching speeches “I turned off TV”, “I turned off the light”, and “I turned on the light” are assigned the commands <SetTVoff>, <SetLightoff>, and <SetLighton> respectively. Furthermore, through morpheme analysis of the recognition results for the teaching speeches, the teaching speeches are separated into morphemes as follows: the teaching speech “I turned off TV: terebi keshita” is separated into three morphemes “terebi”, “keshi”, and “ta”; the teaching speech “I turned off the light: denki keshita” is separated into three morphemes “denki”, “keshi”, and “ta”; and the teaching speech “I turned on the light: denki tsuketa” is separated into three morphemes “denki”, “tsuke”, and “ta”.

Then, the interface apparatus 101 calculates the frequency of each morpheme as illustrated in FIG. 9. For example, with regard to the morpheme “terebi” , since the teaching speech “I turned off TV: terebi keshita” has been inputted once, its frequency for the command <SetTVoff> is one. For example, with regard to the morpheme “denki”, since the teaching speech “I turned off the light: denki keshita” has been inputted once, its frequency for the command <SetLightoff> is one, and since the teaching speech “I turned on the light: denki tsuketa” has been inputted twice, its frequency for the command <SetLighton> is two.

Then, the interface apparatus 101 calculates the agreement index for each morpheme as illustrated in FIG. 9. For example, with regard to the morpheme “denki”, its frequencies for the commands <SetTVoff>, <SetLightoff>, and <SetLighton> are 0, 1, and 2 respectively, and the sum of them is 0+1+2=3, so its agreement indices (frequency divided by total frequency) for the commands <SetTVoff>, <SetLightoff>, and <SetLighton> are 0, 0.33, and 0.66 respectively. Such calculation processes of frequency and agreement index are performed, for example, each time a teaching speech is inputted.

Meanwhile, at S123 in the operation step, the interface apparatus 101 calculates the degree of agreement at morpheme level between the instructing-speech recognition result and each teaching-speech recognition result as illustrated in FIG. 9. FIG. 9 illustrates degrees of agreement of the instructing speech “Turn off the TV” with the commands <SetTVoff>, <SetLightoff>, and <SetLighton> (in FIG. 9, degrees of agreement with the teaching speeches “I turned off the TV”, “I turned off the light”, and “I turned on the light” are illustrated, because they are the all teaching speeches given here).

The degree of agreement between the instructing speech “Turn off the TV: terebi keshite” and the teaching speech “I turned off the TV: terebi keshita” , is the sum of agreement indices between the instructing-speech morphemes “terebi”, “keshi”, and “te” and the teaching speech “I turned off the TV: terebi keshita” (command <SetTVoff>). These agreement indices are 1, 0.5, and 0 respectively, so the degree of agreement between the instructing speech “Turn off the TV” and the command <SetTVoff> is 1.5 (=1+0.5+0).

The degree of agreement between the instructing speech “Turn off the TV: terebi keshite” and the teaching speech “I turned off the light: denki keshita”, is the sum of agreement indices between the instructing-speech morphemes “terebi”, “keshi”, and “te” and the teaching speech “I turned off the light: denki keshita” (command <SetLightoff>). These agreement indices are 0, 0.5, and 0 respectively, so the degree of agreement between the instructing speech “Turn off the TV” and the command <SetLightoff> is 0.5 (=0+0.5+0).

The degree of agreement between the instructing speech “Turn off the TV: terebi keshite” and the teaching speech “I turned on the light: denki tsuketa”, is the sum of agreement indices between the instructing-speech morphemes “terebi”, “keshi”, and “te” and the teaching speech “I turned on the light: denki tsuketa” (command <SetLighton>). These agreement indices are 0, 0, and 0 respectively, so the degree of agreement between the instructing speech “Turn off the TV” and the command <SetLighton> is 0 (=0+0+0).

Then, as shown in FIG. 9, the interface apparatus 101 selects a teaching-speech recognition result that corresponds to the instructing-speech recognition result, based on the degree of agreement between the instructing-speech recognition result and each teaching-speech recognition result at morpheme level, and selects a device operation that corresponds to the instructing-speech recognition result.

For example, since degrees of agreement between the instructing speech “Turn off the TV” and the teaching speeches “I turned off the TV”, “I turned off the light”, and “I turned on the light” are 1.5, 0.5, and 0 respectively, the teaching speech “I turned off the TV” which has the highest degree of agreement is selected as a teaching speech that corresponds to the instructing speech “Turn off the TV”. That is, the command <SetTVoff> is selected as a device operation that corresponds to the instructing speech “Turn off the TV”.

Similarly, since degrees of agreement between the instructing speech “Turn off the light” and the teaching speeches “I turned off the TV”, “I turned off the light”, and “I turned on the light” are 0.5, 0.83, and 0.66 respectively, the teaching speech “I turned off the light” which has the highest degree of agreement is selected as a teaching speech that corresponds to the instructing speech “Turn off the light”. That is, the command <SetLightoff> is selected as a device operation that corresponds to the instructing speech “Turn off the light”.

As described above, in this embodiment, the interface apparatus 101 calculates degree of agreement at morpheme level between a teaching-speech recognition result and an instructing-speech recognition result, based on statistical data about inputted teaching speeches, and determines whether there is a correspondence between a teaching-speech recognition result and an instructing-speech recognition result, based on the calculated degree of agreement. Thereby, with regard to a teaching speech and an instructing speech which are partially different, e.g., the teaching speech “I turned on news” and the instructing speech “Turn on news”, the interface apparatus 101 can determine that they correspond to each other. For example, in the example shown in FIG. 9, the television 201 can be turned off with either of the instructing speeches “Turn off the TV” or “Switch off the TV”. This enables the user 301 to speak with higher degree of freedom in teaching and operating, which enhances the user-friendliness of the interface apparatus 101.

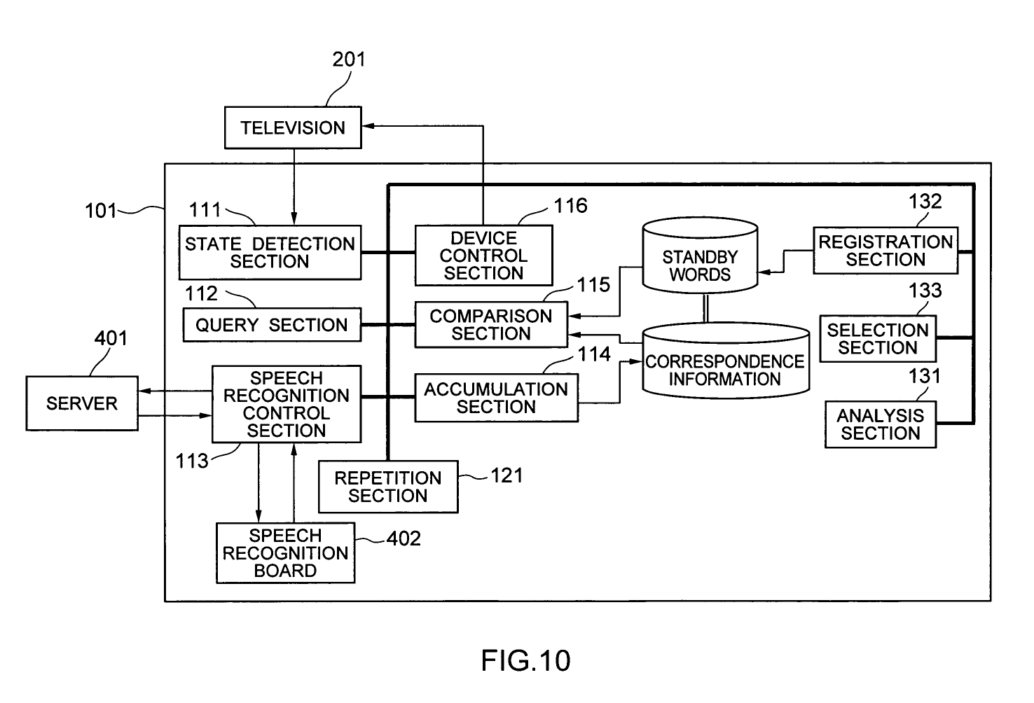

In the example of FIG. 9, when “Turn off” is the instructing speech, there are two teaching speeches that have the highest degree of agreement, i.e., “I turned off the TV” (command <SetTVoff>) and “I turned off the light” (command <SetLightoff>). In this case, the interface apparatus 101 may ask the user 301 what the instructing speech “Turn off” means, by asking by voice like “What do you mean by ‘Turn off’?” or “Turn off?” for example. In this way, when a plurality of teaching speeches have the highest degree of agreement, the interface apparatus 101 may request the user 301 to say the instructing speech again. This enables handling of instructing speeches having high ambiguity. Such a request for respeaking may be performed, not only when a plurality of teaching speeches have the highest degree of agreement, but also when there exists only a slight difference in degree of agreement between a teaching speech having the highest degree and a teaching speech having the next highest degree (e.g. the difference being below a threshold value). A query process relating to a request for respeaking is performed by the query section 112 (FIG. 10). Further, a speech recognition control process for an instructing speech uttered by the user 301 in response to a request for respeaking, is performed by the speech recognition control section 113 (FIG. 10).

According to rules for calculating agreement indices of morphemes in this embodiment, the agreement index of a frequent word that can be used in various teaching speeches tends to gradually become smaller, and the agreement index of an important word that is used only in certain teaching speeches tends to gradually become larger. Consequently, in this embodiment, recognition accuracy for instructing speeches that include important words gradually increases, and misrecognition of instructing speeches that result from frequent words contained in them gradually decreases.

In addition, the interface apparatus 101 selects a morpheme to be a standby word, from one or more morphemes obtained from a teaching-speech recognition result. The interface apparatus 101 selects the morpheme based on agreement index of each morpheme. In this embodiment, as illustrated in FIG. 9, the interface apparatus 101 selects, as a standby word for the teaching speech which corresponds to a device operation (a command), a morpheme which has the highest agreement index for the device operation (the command).

For example, since agreement indices between the morphemes “terebi”, “keshi”, and “ta” of the teaching speech “I turned off the TV: terebi keshita” and the command <SetTVoff> are 1, 0.5, and 0.25 respectively, the standby word for the command <SetTVoff> will be “terebi”.

For example, since agreement indices between the morphemes “denki”, “keshi”, and “ta” of the teaching speech “I turned off the light: denki keshita” and the command <SetLightoff> are 0.33, 0.5, and 0.25 respectively, the standby word for the command <SetLightoff> will be “keshi”.

For example, since agreement indices between the morphemes “denki”, “tsuke”, and “ta” of the teaching speech “I turned on the light: denki tsuketa” and the command <SetLighton> are 0.66, 1, and 0.25 respectively, the standby word for the command <SetLighton> will be “tsuke”.

As described above, in this embodiment, the interface apparatus 101 calculates agreement indices between morphemes of a teaching speech and a command, based on statistical data about inputted teaching speeches, and selects a standby word, based on the calculated agreement indices. Consequently, a morpheme that is appropriate as a standby word from statistical viewpoint is automatically selected. Timing of selecting or registering a morpheme as a standby word may be, for example, the time when the agreement index or frequency of the morpheme has exceeded a predetermined value. Such selection process can be applied to a selection process of a notification word(s) in the second embodiment.

As described above, each of the comparison process at S123 and the selection process at S116 is performed based on a parameter that is calculated utilizing statistical data on inputted teaching speeches. Degree of agreement serves as such a parameter in the comparison process in this embodiment, and agreement index serves as such a parameter in the selection process in this embodiment.

In this embodiment, morpheme analysis in Japanese has been described. The speech processing technique described in this embodiment is applicable to English or other languages, by replacing morpheme analysis in Japanese with morpheme analysis in English or other languages.

FIG. 10 is a block diagram showing the configuration of the interface apparatus 101 of the fourth embodiment.

The interface apparatus 101 of the fourth embodiment includes a state detection section 111, a query section 112, a speech recognition control section 113, a accumulation section 114, a comparison section 115, a device operation section 116, a repetition section 121, a analysis section 131, a registration section 132, and a selection section 133.

The state detection section 111 is a block that performs the state detection process at S101. The query section 112 is a block that performs the query processes at S113 and S131. The speech recognition control section 113 is a block that performs the speech recognition control processes at S115 and S122. The accumulation section 114 is a block that performs the accumulation process at 5116. The comparison section 115 is a block that performs the comparison processes at S111 and S123. The device operation section 116 is a block that performs the device operation process at S124. The repetition section 121 is a block that performs the repetition processes at 5116 and 5124. The analysis section 131 is a block that performs the analysis process at S116. The registration section 132 is a block that performs the registration process at S116. The selection section 133 is a block that performs the selection process at S116.

### Fifth Embodiment

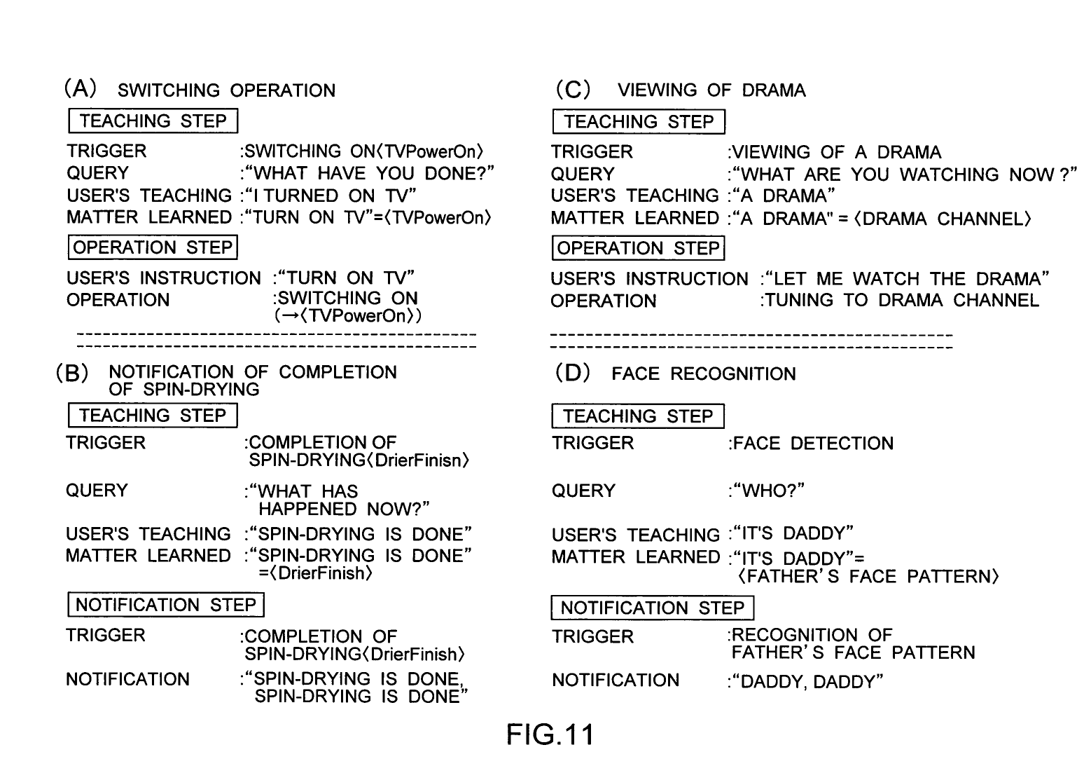

With reference to FIG. 11, interface apparatuses of the fifth embodiment will be described. FIG. 11 illustrates various exemplary operations of various interface apparatuses. The fifth embodiment is a variation of the first to fourth embodiments and will be described mainly focusing on its differences from those embodiments.

The interface apparatus shown in FIG. 11(A) handles a device operation for switching a television on. This is an embodiment in which “channel tuning operation” in the first embodiment is replaced with “switching operation”. The operation of the interface apparatus is similar to the first embodiment.

The interface apparatus shown in FIG. 11(B) provides a user with device information of a spin drier such as completion of spin-drying. This is an embodiment in which “completion of washing by a washing machine” in the second embodiment is replaced with “completion of spin-drying by a spin drier”. The operation of the interface apparatus is similar to the second embodiment.

The interface apparatus shown in FIG. 11(C) handles a device operation for tuning a television to a drama channel. The interface apparatus of the first embodiment detects “a state change (i.e. a change of the state)” of the television such that the television was operated, whereas this interface apparatus detects “a state continuation (i.e. a continuation of the state)” of the television such that viewing of a channel has continued for more than a certain time period. FIG. 11(C) illustrates an exemplary operation in which: in response to a query “What are you watching now?”, a teaching “A drama” is given, and in response to an instruction “Let me watch the drama”, a device operation ‘tuning to a drama channel’ is performed. A variation for detecting a state continuation of a device can be realized in the second embodiment as well.

The interface apparatus shown in FIG. 11(D) provides device information of a refrigerator such that a user is approaching the refrigerator. The interface apparatus of the second embodiment detects a state change (i.e. a change of the state) of “the washing machine” such that an event occurred on the washing machine, whereas this interface apparatus detects a state change (i.e. a change of the state) of “the vicinity of the refrigerator” such that an event occurred in the vicinity of the refrigerator. FIG. 11(D) illustrates an exemplary operation in which: in response to a query “Who?”, a teaching “It's Daddy” is given, and in response to a state change of the vicinity of the refrigerator ‘appearance of Daddy’, a voice notification “It's Daddy” is performed. For the determination process of determining who is approaching the refrigerator, a face recognition technique, which is a kind of image recognition technique, can be utilized. A variation for detecting a state change of the vicinity of a device can be realized in the first embodiment as well. Further, a variation for detecting a state continuation of the vicinity of a device can be realized in the first and second embodiments as well.

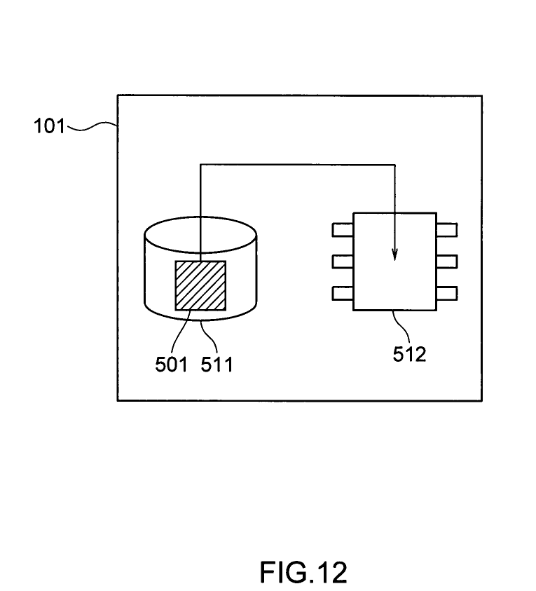

The functional blocks shown in FIG. 4 (first embodiment) can be realized, for example, by a computer program (an interface processing program). Similarly, those shown in FIG. 7 (second embodiment) can be realized, for example, by a computer program. Similarly, those shown in FIG. 8 (third embodiment) can be realized, for example, by a computer program. Similarly, those shown in FIG. 10 (fourth embodiment) can be realized, for example, by a computer program. The computer program is illustrated in FIG. 12 as a program 501. The program 501 is, for example, stored in a storage 511 of the interface apparatus 101, and executed by a processor 512 in the interface apparatus 101, as illustrated in FIG. 12.

As described above, the embodiments of the present invention provide a user-friendly speech interface that serves as an intermediary between a device and a user.

What is claimed is:

1. An interface apparatus configured to perform a device operation in response to a voice instruction from a user, comprising:
a state detection section configured to detect a state change or state continuation of a device or the vicinity of the device;
a query section configured to query a user by voice about the meaning of the detected state change or state continuation;
a speech recognition control section configured to have one or more speech recognition units recognize a teaching speech uttered by the user in response to the query and an instructing speech uttered by a user for a device operation, the one or more speech recognition units being configured to recognize the teaching speech and the instructing speech;
an accumulation section configured to associate a recognition result for the teaching speech with a detection result for the state change or state continuation, and accumulate a correspondence between the recognition result for the teaching speech and the detection result for the state change or state continuation;
a comparison section configured to compare a recognition result for the instructing speech with accumulated correspondences between recognition results for teaching speeches and detection results for state changes or state continuations, and select a device operation specified by a detection result for a state change or state continuation that corresponds to the recognition result for the instructing speech; and
a device operation section configured to perform the selected device operation.

2. An interface apparatus configured to notify device information to a user by voice, comprising:
a state detection section configured to detect a state change or state continuation of a device or the vicinity of the device;
a query section configured to query a user by voice about the meaning of the detected state change or state continuation;
a speech recognition control section configured to have a speech recognition unit recognize a teaching speech uttered by the user in response to the query, the speech recognition unit being configured to recognize the teaching speech;
an accumulation section configured to associate a detection result for the state change or state continuation with a recognition result for the teaching speech, and accumulate a correspondence between the detection result for the state change or state continuation and the recognition result for the teaching speech;
a comparison section configured to compare a detection result for a newly detected state change or state continuation with accumulated correspondences between detection results for state changes or state continuations and recognition results for teaching speeches, and select a notification word that corresponds to the detection result for the newly detected state change or state continuation; and
a notification section configured to notify device information to a user by voice, by converting the selected notification word into sound.

3. The apparatus according to claim 1, wherein the speech recognition control section
has the teaching speech be recognized by a speech recognition unit for connected speech recognition, and
has the instructing speech be recognized by a speech recognition unit for connected speech recognition or a speech recognition unit for isolated word recognition.

4. The apparatus according to claim 3, further comprising: a registration section configured to register the recognition result for the teaching speech by connected speech recognition, as a standby word for recognizing an instructing speech by isolated word recognition,
wherein the speech recognition unit for isolated word recognition recognizes the instructing speech by comparing the instructing speech with the registered standby word.

5. The apparatus according to claim 4, further comprising: an analysis section configured to analyze the recognition result for the teaching speech by connected speech recognition, and obtain a morpheme from one or more recognized words which are the recognition result for the teaching speech by connected speech recognition,
wherein the registration section registers the morpheme as the standby word.

6. The apparatus according to claim 5, further comprising: a selection section configured to select a morpheme to be a standby word, from one or more morphemes obtained from the recognized words,
wherein the registration section registers the selected morpheme as the standby word.

7. The apparatus according to claim 3, wherein the comparison section selects the device operation based on a parameter which is calculated utilizing statistical data on teaching speeches inputted to the interface apparatus.

8. The apparatus according to claim 6, wherein the selection section selects the morpheme to be a standby word based on a parameter which is calculated utilizing statistical data on teaching speeches inputted to the interface apparatus.

9. The apparatus according to claim 4, wherein the speech recognition control section
has the instructing speech be recognized by the speech recognition unit for connected speech recognition, in standby-off state in which the instructing speech is recognized without using the standby word, and
has the instructing speech be recognized by the speech recognition unit for isolated word recognition, in standby-on state in which the instructing speech is recognized using the standby word.

10. The apparatus according to claim 1, further comprising: a repetition section configured to repeat the recognition result for the teaching speech after recognition of the teaching speech.

11. The apparatus according to claim 1, further comprising: a repetition section configured to repeat a repetition word that corresponds to the recognition result for the instructing speech after recognition of the instructing speech.

12. The apparatus according to claim 2, wherein the speech recognition control section has the teaching speech be recognized by a speech recognition unit for connected speech recognition.

13. An interface processing method of performing a device operation in response to a voice instruction from a user, comprising:
detecting a state change or state continuation of a device or the vicinity of the device;
querying a user by voice about the meaning of the detected state change or state continuation;
having a speech recognition unit recognize a teaching speech uttered by the user in response to the query, the speech recognition unit being configured to recognize the teaching speech;
associating a recognition result for the teaching speech with a detection result for the state change or state continuation, and accumulating a correspondence between the recognition result for the teaching speech and the detection result for the state change or state continuation;
having a speech recognition unit recognize an instructing speech uttered by a user for a device operation, the speech recognition unit being configured to recognize the instructing speech;
comparing a recognition result for the instructing speech with accumulated correspondences between recognition results for teaching speeches and detection results for state changes or state continuations, and selecting a device operation specified by a detection result for a state change or state continuation that corresponds to the recognition result for the instructing speech; and
performing the selected device operation.

14. An interface processing method of notifying device information to a user by voice, comprising:
detecting a state change or state continuation of a device or the vicinity of the device;
querying a user by voice about the meaning of the detected state change or state continuation;
having a speech recognition unit recognize a teaching speech uttered by the user in response to the query, the speech recognition unit being configured to recognize the teaching speech;
associating a detection result for the state change or state continuation with a recognition result for the teaching speech, and accumulating a correspondence between the detection result for the state change or state continuation and the recognition result for the teaching speech;
comparing a detection result for a newly detected state change or state continuation with accumulated correspondences between detection results for state changes or state continuations and recognition results for teaching speeches, and selecting a notification word that corresponds to the detection result for the newly detected state change or state continuation; and
notifying device information to a user by voice, by converting the selected notification word into sound.

15. The method according to claim 13, wherein the method
has the teaching speech be recognized by a speech recognition unit for connected speech recognition, and
has the instructing speech be recognized by a speech recognition unit for connected speech recognition or a speech recognition unit for isolated word recognition.

16. The method according to claim 13, wherein further comprising: repeating the recognition result for the teaching speech after recognition of the teaching speech.

17. The method according to claim 13, wherein further comprising: repeating a repetition word that corresponds to the recognition result for the instructing speech after recognition of the instructing speech.

18. The method according to claim 14, wherein the method has the teaching speech be recognized by a speech recognition unit for connected speech recognition.

19. An interface processing program of having a computer perform an information processing method of performing a device operation in response to a voice instruction from a user, the method comprising:
detecting a state change or state continuation of a device or the vicinity of the device;
querying a user by voice about the meaning of the detected state change or state continuation;
having a speech recognition unit recognize a teaching speech uttered by the user in response to the query, the speech recognition unit being configured to recognize the teaching speech;
associating a recognition result for the teaching speech with a detection result for the state change or state continuation, and accumulating a correspondence between the recognition result for the teaching speech and the detection result for the state change or state continuation;
having a speech recognition unit recognize an instructing speech uttered by a user for a device operation, the speech recognition unit being configured to recognize the instructing speech;
comparing a recognition result for the instructing speech with accumulated correspondences between recognition results for teaching speeches and detection results for state changes or state continuations, and selecting a device operation specified by a detection result for a state change or state continuation that corresponds to the recognition result for the instructing speech; and
performing the selected device operation.

20. An interface processing program of having a computer perform an information processing method of notifying device information to a user by voice, the method comprising:
detecting a state change or state continuation of a device or the vicinity of the device;
querying a user by voice about the meaning of the detected state change or state continuation;
having a speech recognition unit recognize a teaching speech uttered by the user in response to the query, the speech recognition unit being configured to recognize the teaching speech;
associating a detection result for the state change or state continuation with a recognition result for the teaching speech, and accumulating a correspondence between the detection result for the state change or state continuation and the recognition result for the teaching speech;
comparing a detection result for a newly detected state change or state continuation with accumulated correspondences between detection results for state changes or state continuations and recognition results for teaching speeches, and selecting a notification word that corresponds to the detection result for the newly detected state change or state continuation; and
notifying device information to a user by voice, by converting the selected notification word into sound.
